(19) United States
(12) Patent Application Publication
(10) Pub. No.: US 2010/0125506 A1
(43) Pub. Date: May 20, 2010

(54) EXTENDED GENERALIZED SECOND PRICE AUCTION FOR SPONSORED SEARCH WITH RESERVE PRICES

(75) Inventors: Sergei Vassilvitskii, New York, NY (US); Colin Brady, Sunnyvale, CA (US); Rica Gonen, Sunnyvale, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/274,464

(22) Filed: Nov. 20, 2008

(51) Int. Cl. G06Q 30/00

(52) U.S. Cl. 705/14.69; 705/26

(57) ABSTRACT

Search engines and sponsored search auctions are provided that enable the use of different reserve prices corresponding to different advertisement slots on a search results page. In one implementation, a search engine includes a query processor and a sponsored search auction. The query processor is configured to receive a query from an electronic device associated with a user, to determine a plurality of reserve prices corresponding to a plurality of advertisement slots of a search results page, and to determine a plurality of bid prices for the advertisement slots of the search results page corresponding to a plurality of bidders. The sponsored search auction is configured to allocate a bidder or a null (e.g., no advertisement) to each advertisement slot of the search results page, taking into account the plurality of reserve prices associated with the advertisement slots of the search results page.

### BACKGROUND OF THE INVENTION

1. Field of the Invention

The present invention relates to online advertising, and in particular, to search engine-related advertising.

2. Background Art

A search engine is an information retrieval system used to locate documents and other information stored on a computer system. Search engines are useful at reducing an amount of time required to find information. One well known type of search engine is a Web search engine which searches for documents, such as web pages, on the “World Wide Web.” Examples of such search engines include Yahoo! Search™ (at http://www.yahoo.com), Ask.com™ (at http://www.ask.com), and Google™ (at http://www.google.com). Online services such as LexisNexis™ and Westlaw™ also enable users to search for documents provided by their respective services, including articles and court opinions. Further types of search engines include personal search engines, mobile search engines, and enterprise search engines that search on intranets, among others.

To perform a search, a user of a search engine supplies a query to the search engine. The query contains one or more words/terms, such as “hazardous waste” or “country music.” The terms of the query are typically selected by the user to as an attempt find particular information of interest to the user. The search engine returns a list of documents relevant to the query. In a Web-based search, the search engine typically returns a list of uniform resource locator (URL) addresses for the relevant documents, which is displayed to the user in a search results page. If the scope of the search resulting from a query is large, the returned list of documents may include thousands or even millions of documents.

“Sponsored search” refers to a form of Internet advertising/marketing that enables advertisers to increase their visibility in the results page of a search engine query.

According to sponsored search, an advertiser may pay or provide other compensation for having an advertisement appear in a sponsored section of the results page for one or more particular queries. A user who enters one of the queries into the search engine is provided with a results page that includes the advertisement in the sponsored search section. The sponsored search section is prominently displayed in the results page, to enable the user to easily see and interact with the advertisement. In this manner, an advertiser is enabled to provide advertisements to users that are directly related to their queries, and a search engine owner/operator is enabled to further monetize the search engine.

A large number of advertisers may want to display advertisements with respect to a particular query. A number of advertisement slots on a search results page for a query may be less than the number of advertisers that want to display their advertisements for the query. Furthermore, the advertisers may value some advertisement positions (“advertisement slots”) in the search results page higher than others. As a result, sponsored search auctions have been created that enable advertisers to bid on queries. In a sponsored search auction, each advertiser specifies the query with which they desire for their advertisement to be displayed with, and submits a bid, which represents the maximum amount the advertiser is willing to pay to have an advertisement displayed. When a user enters a query, the advertisers bidding for the query are determined, and a generalized second price auction is performed to determine the winning bidders (e.g., the advertisers that will have their advertisements displayed) and the prices that each winning bidder will be charged. There are usually multiple winning bidders, because there are typically multiple advertiser slots on a search result page, with higher slots on the page typically being more valuable since they are more likely to be seen by more users. In a “pay-per-click” scheme, a winning bidder may be charged only in the event that a user actually clicks on the displayed advertisement.

Current sponsored search auctions are inefficient. For example, current sponsored search engines use identical reserve prices (a minimum price an advertiser must pay to win an advertisement slot in an auction) for each advertisement slot of a page. What is desired are improved techniques for sponsored search auctions that increase the amount of generated revenue relative to current techniques.

### BRIEF SUMMARY OF THE INVENTION

Search engines and sponsored search auctions are provided that enable the use of more than one reserve price, with each reserve price corresponding to one or more different advertisement slots on a search results page. The use of multiple reserve prices enables enhanced revenue generation from advertisement sales for a search engine operator/owner.

In one implementation, a method for a sponsored search auction is provided. A highest reserve price of a plurality of reserve prices corresponding to a plurality of advertisement slots of a page is selected. A highest bid price of a plurality of bid prices for the advertisement slots of the page corresponding to a plurality of bidders is selected. The highest bid price is compared to the highest reserve price. A null (e.g., no advertisement) or a bidder corresponding to the highest bid price is allocated to the advertisement slot corresponding to the highest reserve price based on the comparing. The comparing and the allocating are repeated for a next highest bid price and a next highest reserve price if a bidder is allocated to the advertisement slot during the immediately preceding allocating and if all advertisements slots are not yet allocated. The comparing and the allocating are repeated for a next highest reserve price if a null is allocated to the advertisement slot during the immediately preceding allocating and if all advertisements slots are not yet allocated.

In one example, the allocating is performed as follows: If the highest bid price is greater than the highest reserve price, a bidder corresponding to the highest bid price is allocated to the advertisement slot corresponding to the highest reserve price, and a cost is assigned to the bidder of a greater one of the highest reserve price or a next highest bid price. If the highest bid price is less than the highest reserve price, a null is allocated to the advertisement slot corresponding to the highest reserve price.

In another implementation, a search engine is provided. The search engine includes a query processor and a sponsored search auction. The query processor is configured to receive a query from an electronic device associated with a user, to determine a plurality of reserve prices corresponding to a plurality of advertisement slots of a search results page for the query (to be displayed by a display of the electronic device of the user), and to determine a plurality of bid prices for the advertisement slots of the search results page corresponding to a plurality of bidders. The sponsored search auction is configured to allocate a bidder or a null to each advertisement slot of the search results page.

In one example, the sponsored search auction includes a reserve price selector, a bid price selector, a price compare module, and an advertisement slot allocator. The reserve price selector is configured to select a highest reserve price of the plurality of reserve prices corresponding to a plurality of advertisement slots of a page. The bid price selector is configured to select a highest bid price of the plurality of bid prices for the advertisement slots of the page corresponding to the plurality of bidders. The price compare module is configured to compare the highest bid price to the highest reserve price of the plurality of reserve prices corresponding to an advertisement slot that is unallocated, and to generate a compare result. The advertisement slot allocator is configured to allocate a null or a bidder corresponding to the highest bid price to the advertisement slot corresponding to the highest reserve price based on the compare result. The price compare module is further configured to repeat performing the comparison and the advertisement slot allocator is further configured to repeat performing the allocation for a next highest bid price selected by the bid price selector and a next highest reserve price selected by the reserve price selector if a bidder is allocated to the advertisement slot during an immediately preceding allocation performed by the advertisement slot allocator and if all advertisements slots are not yet allocated. The price compare module is configured to repeat performing the comparison and the advertisement slot allocator is configured to repeat performing the allocation for a next highest reserve price selected by the reserve price selector if a null is allocated to the advertisement slot during an immediately preceding allocation performed by the advertisement slot allocator and if all advertisements slots are not yet allocated.

Furthermore, the advertisement slot allocator is configured to allocate a bidder corresponding to the highest bid price to the advertisement slot corresponding to the highest reserve price, and to assign a cost to the bidder of a greater one of the highest reserve price or a next highest bid price if the comparison result indicates that the highest bid price is greater than the highest reserve price.

Still further, the advertisement slot allocator is configured to allocate a null to the advertisement slot corresponding to the highest reserve price if the comparison result indicates that the selected highest bid price is less than the highest reserve price.

Computer program products are also described herein. The computer program products include a computer-readable medium having computer program logic recorded thereon for enabling search engines and sponsored search auctions, according to the implementations described herein.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a document retrieval system.

FIG. 2 shows an example query that may be submitted by a user to a search engine.

FIG. 3 shows search results displayed on a webpage by a search engine in response to an example query.

FIG. 4 shows a block diagram of a search engine, according to an example embodiment of the present invention.

FIG. 5 shows a flowchart for performing a sponsored search auction, according to an example embodiment of the present invention.

FIG. 6 shows a block diagram of a sponsored search auction, according to an example embodiment of the present invention.

FIG. 7 shows a flowchart for allocating advertisement slots, according to an example embodiment of the present invention.

FIG. 8 shows a block diagram of an example computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

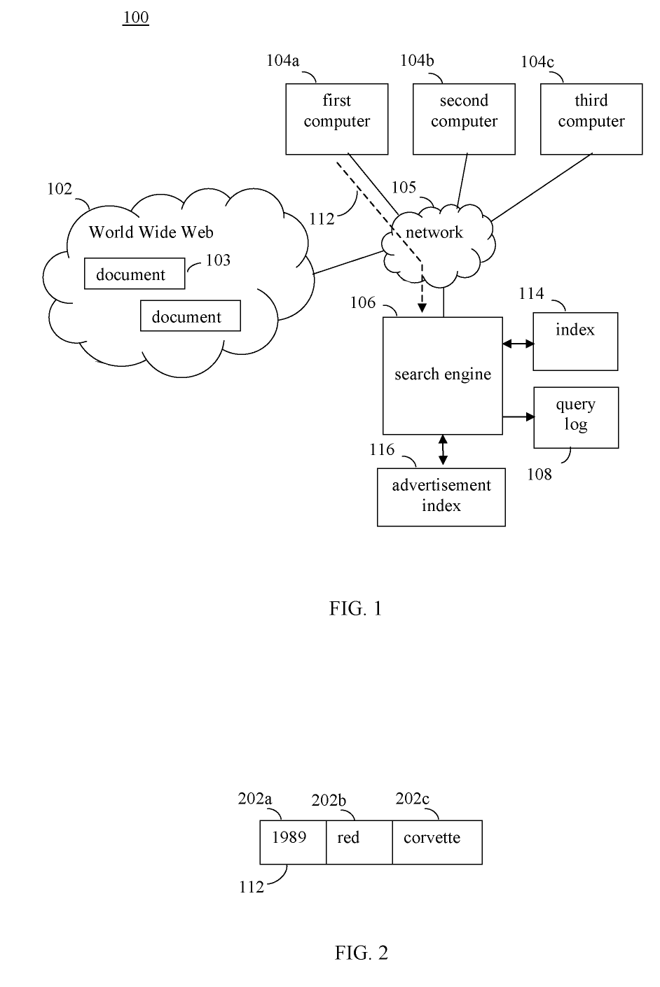

Embodiments of the present invention enable the use of multiple reserve prices in sponsored search applications. FIG. 1 shows an example environment in which sponsored search may be implemented. FIG. 1 shows a document retrieval system 100, according to an example embodiment of the present invention. As shown in FIG. 1, system 100 includes a search engine 106. One or more computers 104, such as first-third computers 104a-104c, are connected to a communication network 105. Network 105 may be any type of communication network, such as a local area network (LAN), a wide area network (WAN), or a combination of communication networks. In embodiments, network 105 may include the Internet and/or an intranet. Computers 104 can retrieve documents from entities over network 105. Computers 104 may each be any type of suitable electronic device, typically having a display, that has web browsing capability, including a desktop computer, a mobile computer (e.g., a laptop computer or a notebook computer), smart phone, etc. In embodiments where network 105 includes the Internet, a collection of documents, including a document 103, which form a portion of World Wide Web 102, are available for retrieval by computers 104 through network 105. On the Internet, documents may be identified/located by a uniform resource locator (URL), such as http://www.documents.com/documentX, and/or by other mechanisms. Computers 104 can access document 103 through network 105 by supplying a URL corresponding to document 103 to a document server (not shown in FIG. 1).

As shown in FIG. 1, search engine 106 is coupled to network 105. Search engine 106 accesses a stored index 114 that indexes documents, such as documents of World Wide Web 102. A user of computer 104a who desires to retrieve one or more documents relevant to a particular topic, but does not know the identifier/location of such a document, may submit a query 112 to search engine 106 through network 105. Search engine 106 receives query 112, and analyzes index 114 to find documents relevant to query 112. For example, search engine 106 may determine a set of documents indexed by index 114 that include terms of query 112. The set of documents may include any number of documents, including tens, hundreds, thousands, or even millions of documents. Search engine 106 may use a ranking or relevance function to rank documents of the retrieved set of documents in an order of relevance to the user. Documents of the set determined to most likely be relevant may be provided at the top of a list of the returned documents in an attempt to avoid the user having to parse through the entire set of documents.

Search engine 106 may be implemented in hardware, software, firmware, or any combination thereof. For example, search engine 106 may include software/firmware that executes in one or more processors of one or more computer systems, such as one or more servers. Examples of search engine 106 that may be accessible through network 105 include, but are not limited to, Yahoo! Search™ (at http://www.yahoo.com), Ask.com™ (at http://www.ask.com), and Google™ (at http://www.google.com).

FIG. 2 shows an example query 112 that may be submitted by a user of one of computers 104a-104c of FIG. 1 to search engine 106. Query 112 includes one or more terms 202, such as first, second, and third terms 202a-202c shown in FIG. 2. Any number of terms 202 may be present in a query. As shown in FIG. 2, terms 202a-202c of query 112 are “1989,” “red,” and “corvette.” Search engine 106 applies these terms 202a-202c to index 114 to retrieve a document locator, such as a URL, for one or more indexed documents that match 1989,” “red,” and “corvette,” and may order the list of documents according to a ranking. As shown in FIG. 1, search engine 106 may generate a query log 108. Query log 108 is a record of searches that are made using search engine 106.

“Sponsored search” refers to a form of Internet advertising/marketing that enables advertisers to increase their visibility in the results page of a search engine query. In sponsored search, an advertiser may pay or provide other consideration for having information, such as a link to a website of the advertiser, appear in a sponsored section of the results webpage for one or more particular queries. The sponsored section is prominently displayed in the results page, to enable the user to easily view and interact with the displayed information of the advertiser. In this manner, an advertiser is enabled to provide advertisements to users that are directly related to their queries, and a search engine owner/operator is enabled to further monetize the search engine.

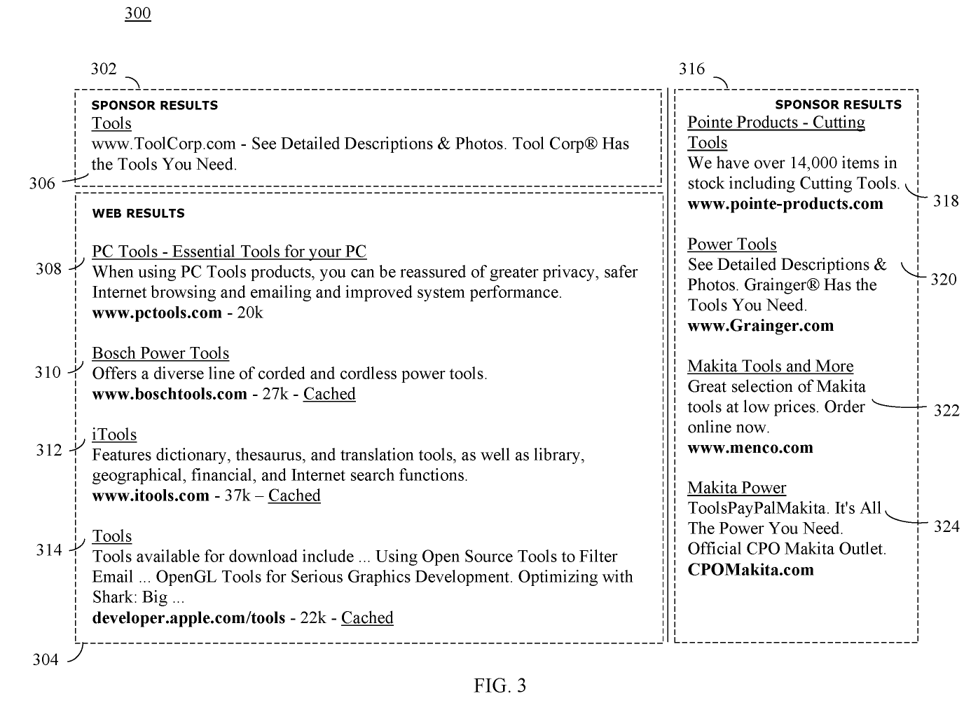

FIG. 3 shows example search results, including sponsored search results, displayed on a webpage 300 generated by search engine 106 in response to a single-term query “tools.” Search engine 106 may analyze the query “tools” to determine whether the query relates to one or more particular advertisers and/or advertisements, and if so, may display advertisements of the advertisers in the form of sponsored links. For example, as shown in FIG. 1, search engine 106 may access an advertisement index 116. Advertisement index 116 may include a mapping of queries to advertisers/advertisements. When search engine 106 receives a query, search engine 106 may access advertisement index 116 to determine whether advertisers/advertisements are present that correspond to the query, and if so, to select one or more advertisers to have their advertisements displayed as sponsored search results for the query.

In many cases, an auction is used to sell sponsored search advertisements. An auction system may be used to enable advertisers to bid to provide advertising for queries. A separate auction is run for each query. Different auction techniques may be used to assign costs to the bidding advertisers, such as a “first price auction,” a “second price auction,” or other valuation method. For a first price auction, a highest bidder is listed first (e.g., in the most prominent position) in the sponsored search section of the results page, and pays (e.g., per click) the highest bid amount. For a second price auction, the highest bidder is listed first in the sponsored search section of the results page, and pays the second highest bid amount (the second highest bidder is listed second and pays the third highest bid amount, etc.).

In the example of FIG. 3, search engine 106 determined that the query “tools” relates to advertisements of various companies, which in the current example are advertisers that provide advertisements to be displayed in search results pages generated by search engine 106. In webpage 300, which is generated in response to the “tools” query, search engine 106 displays a first advertisement page portion 302, a search results page portion 304, and a second advertisement page portion 316. As shown in FIG. 3, search results page portion 304 lists search results for the query “tools,” including documents/links 308, 310, 312, and 314 (further resulting document/links are not shown in FIG. 3 for purposes of brevity), in a standard fashion for search engine 106. First advertisement page portion 302 includes a first advertisement 306 in the form of advertisement text and a sponsored link (e.g., www.ToolCorp.com) of a tool-related advertiser (e.g., Tool Corp). First advertisement 306 is the most prominently displayed advertisement on webpage 300, being displayed centrally and above search results page portion 304. Second advertisement page portion 316 lists second-fifth advertisements 318, 320, 322, and 324 from top to bottom in a right-side column of advertisements. Second-fifth advertisements 318, 320, 322, and 324 each include advertisement text and a sponsored link for a tool-related advertiser. First-fifth advertisements 306, 318, 320, 322, and 324 may have been selected for display on a webpage 300 by performing a sponsored search auction. Although five sponsored links are provided in the example of FIG. 3, alternate numbers of sponsored links may be provided. In this manner, a search engine may display search results for a query, and may match advertisers with computer users who may be interested in a product or service of the advertiser according to the query entered by the user.

Conventional sponsored search auctions have disadvantages. Current sponsored search auctions that take into account a reserve price, which is a minimum price an advertiser must pay to win an auction, use an identical reserve price for each advertisement slot of a page. As a result, a significant loss in revenue to the search engine (e.g., to an owner, operator, and/or controlling entity of search engine 106) may occur. Thus, what is desired are improved techniques for sponsored search auctions that increase the amount of generated revenue relative to current sponsored search auctions.

Embodiments of the present invention enable different reserve prices for different advertisement slots in a sponsored search auction. Example embodiments of the present invention are described in detail in the following section.

### Example Sponsored Search Auction Embodiments

Example embodiments are described for sponsored search auctions. The example embodiments described herein are provided for illustrative purposes, and are not limiting. Further structural and operational embodiments, including modifications/alterations, will become apparent to persons skilled in the relevant art(s) from the teachings herein.

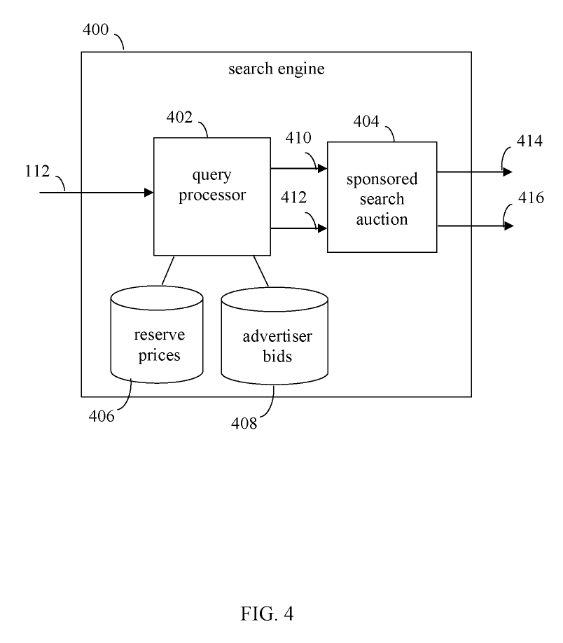

FIG. 4 shows a block diagram of a search engine 400, according to an example embodiment of the present invention. Search engine 400 may be used in system 100 shown in FIG. 1 for search engine 106, in an embodiment. As shown in FIG. 4, search engine 400 includes a query processor 402, a sponsored search auction 404, a reserve prices database 406, and an advertiser bids database 408. Search engine 400 is described as follows.

As shown in FIG. 4, search engine 400 receives query 112. As described above, query 112 includes one or more search terms that a submitting user desires to search on. Search engine 400 may access a stored index (e.g., stored index 114 of FIG. 1) that indexes documents, to find documents relevant to query 112. Search engine 400 may use a ranking or relevance function to rank documents of the retrieved set of documents in an order of relevance to the user. A list of the ranked documents is returned by search engine 400 to the user to be displayed in a resulting search results webpage (e.g., in search results page portion 304 of webpage 300 shown in FIG. 3).

Furthermore, query processor 402 receives query 112. Query processor 402 is configured to access reserve prices database 406 to retrieve reserve prices for sponsored search advertisement slots that may include advertisements to be displayed in the resulting search results webpage. Query processor 402 is also configured to access advertiser bids database 408 to retrieve a list of advertisers and associated bids submitted by the advertisers related to query 112. As shown in FIG. 4, query processor 402 outputs a plurality of reserve prices 410 and a plurality of advertiser bids 412.

Sponsored search auction 404 receives plurality of reserve prices 410 and plurality of advertiser bids 412. Sponsored search auction 404 is configured to perform a sponsored search auction to determine the winning advertisers that will be enabled to have their advertisements displayed on the resulting search results webpage (e.g., in first advertisement page portion 302 or second advertisement page portion 316 of webpage 300 shown in FIG. 3), and the prices that each winning advertiser may be charged. As shown in FIG. 4, sponsored search auction 404 generates an advertisement slot allocation 414. Advertisement slot allocation 414 indicates which bidding advertisers are allocated to which advertisement slots. This advertisement slot allocation may be provided to an advertisement server, which transmits advertisements of the indicated winning advertisers to the requesting user's computer to be displayed in the sponsored search portion of the search results webpage in a determined order. Advertisement slot allocation 414 further indicates the prices that each winning advertiser may be charged. This cost information may be provided to the appropriate winning advertisers for payment if their advertisements are displayed and/or are clicked on (e.g., in a pay-per-click arrangement).

Search engine 400, including query processor 402 and sponsored search auction 404, may be implemented in hardware, software, firmware, or any combination thereof. For example, search engine 400 may be hosted in one or more computer systems that each includes one or more processors and/or logic configured to enable the functionality of search engine 400.

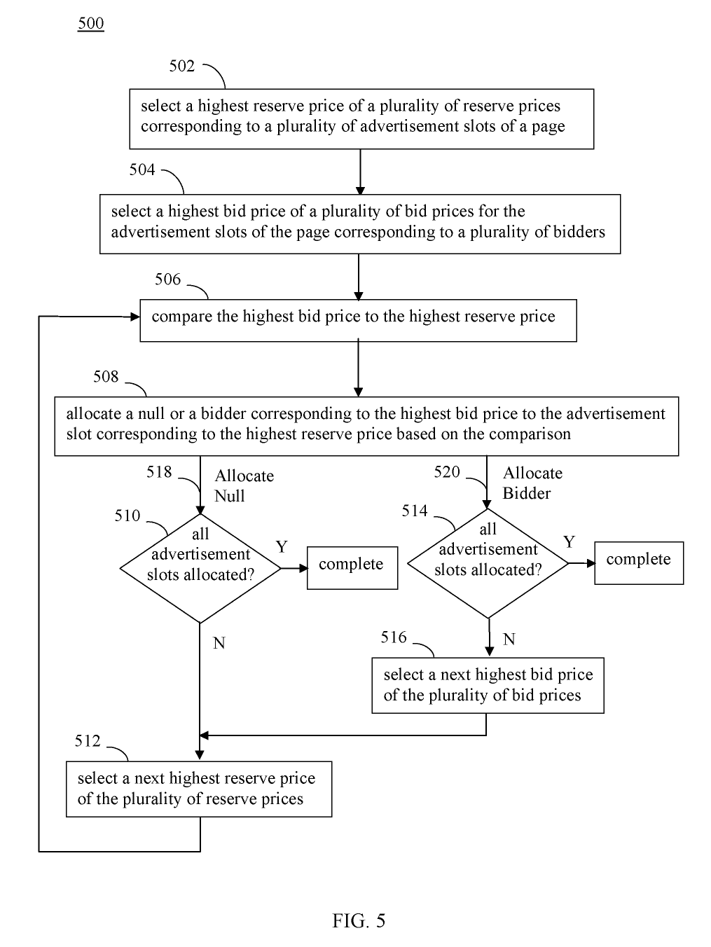

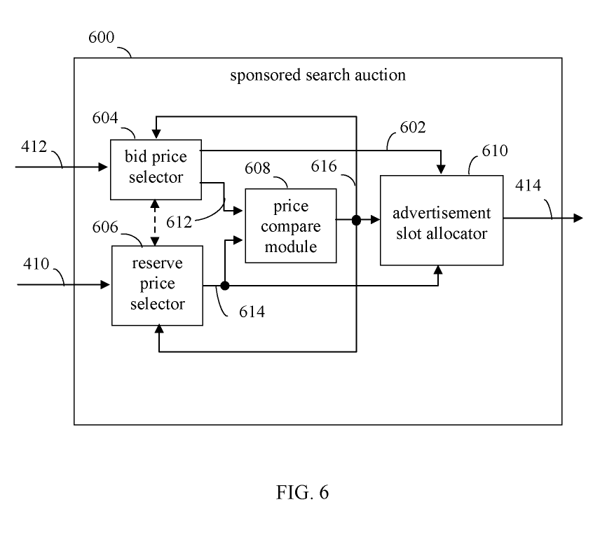

Sponsored search auction 404 may operate in a variety of ways. For example, FIG. 5 shows a flowchart 500 for performing a sponsored search auction, according to an example embodiment of the present invention. Flowchart 500 may be performed by sponsored search auction 404. Further structural and operational embodiments will be apparent to persons skilled in the relevant art(s) based on the discussion regarding flowchart 500. For instance, FIG. 6 shows a block diagram of a sponsored search auction 600, according to an example embodiment of the present invention. Sponsored search auction 600 is an example of sponsored search auction 404 shown in FIG. 4. As shown in FIG. 6, sponsored search auction 600 includes a bid price selector 604, a reserve price selector 606, a price compare module 608, and an advertisement slot allocator 610. In an embodiment, sponsored search auction 600 may operate according to flowchart 500. Flowchart 500 is described as follows with respect to sponsored search auction 600, for illustrative purposes. Note that the steps of flowchart 500 need not necessarily be performed in the order shown in FIG. 5.

Flowchart 500 begins with step 502. In step 502, a highest reserve price of a plurality of reserve prices corresponding to a plurality of advertisement slots of a page is selected. For instance, in an embodiment, reserve price selector 606 may perform step 502. As shown in the embodiment of FIG. 6, reserve price selector 606 receives plurality of reserve prices 410 (e.g., from query processor 402 shown in FIG. 4). Reserve prices 410 are reserve prices corresponding to the webpage to be displayed for the current query received from a user (e.g., query 112). Reserve price selector 606 scans reserve prices 410 for a highest reserve price. As shown in FIG. 6, reserve price selector 606 outputs a highest reserve price 614. As shown in FIG. 5, operation proceeds from step 502 to step 504.

In step 504, a highest bid price of a plurality of bid prices for the advertisement slots of the page corresponding to a plurality of bidders is selected. For instance, in an embodiment, bid price selector 604 may perform step 504. As shown in the embodiment of FIG. 6, bid price selector 604 receives plurality of advertiser bids 412 (e.g., from query processor 402 shown in FIG. 4). Advertiser bids 412 are bid prices for advertisement slots in the search results web page corresponding to the current query received from a user (e.g., query 112). Advertiser bids 412 are received from bidders, which may be advertisers or other entities. Bid price selector 604 scans advertiser bids 412 for a highest bid. As shown in FIG. 6, bid price selector 604 outputs a highest bid price 612. As shown in FIG. 5, operation proceeds from step 504 to step 506.

In step 506, the highest bid price is compared to the highest reserve price. For instance, in an embodiment, price compare module 608 may perform step 506. As shown in FIG. 6, price compare module 608 receives highest reserve price 614 and highest bid price 612. Price compare module 608 compares highest reserve price 614 to highest bid price 612, and generates a comparison result 616, which indicates whether highest bid price 612 is greater than or is less than highest reserve price 614. As shown in FIG. 5, operation proceeds from step 506 to step 508.

In step 508, a null or a bidder corresponding to the highest bid price is allocated to the advertisement slot corresponding to the highest reserve price based on the comparison. For example, in an embodiment, advertisement slot allocator 610 may perform step 508. As shown in FIG. 6, advertisement slot allocator 610 receives comparison result 616. Advertisement slot allocator 610 allocates the current advertisement slot, which corresponds to the current selected highest reserve price 614, according to comparison result 616. Depending on comparison result 616, advertisement slot allocator 610 allocates a null or allocates the bidder that submitted the current selected highest bid price 612 to the current advertisement slot.

If a null is allocated to the advertisement slot by advertisement slot allocator 610, this means that no advertisement is allocated to the advertisement slot. Thus, the advertisement slot may be displayed to the user as empty in the resulting search results webpage. As shown in FIG. 6, advertisement slot allocator 610 generates advertisement slot allocation 414. Depending on the particular implementation, if a null is allocated to the current advertisement slot, this null may be indicated in advertisement slot allocation 414 for the current advertisement slot, or the current advertisement slot may not be indicated at all in advertisement slot allocation 414. In an embodiment, a subsequent advertisement selection algorithm may optionally be used to select an advertisement to be displayed in an advertisement slot that is allocated a null by advertisement slot allocator 610.

If a bidder that submitted the current selected highest bid price 612 is allocated to the advertisement slot by advertisement slot allocator 610, this means that an advertisement provided by the bidder (e.g., the advertiser) corresponding to the current selected highest bid price 612 may be displayed in the advertisement slot in the resulting search results webpage. As shown in FIG. 6, advertisement slot allocator 610 generates advertisement slot allocation 414. If a bidder is allocated to the current advertisement slot, this bidder is indicated for the current advertisement slot in advertisement slot allocation 414, and advertisement slot allocator 610 generates a cost to the bidder for placing an advertisement in the current advertisement slot and/or having the placed advertisement clicked on (e.g., in a pay-per-click arrangement).

As shown in flowchart 500 and FIG. 5, if a null is allocated by advertisement slot allocator 610 (as indicated by “allocate null 518”), operation proceeds to step 510. If a bidder is allocated by advertisement slot allocator 610 (as indicated by “allocate bidder 520”), operation proceeds to step 514.

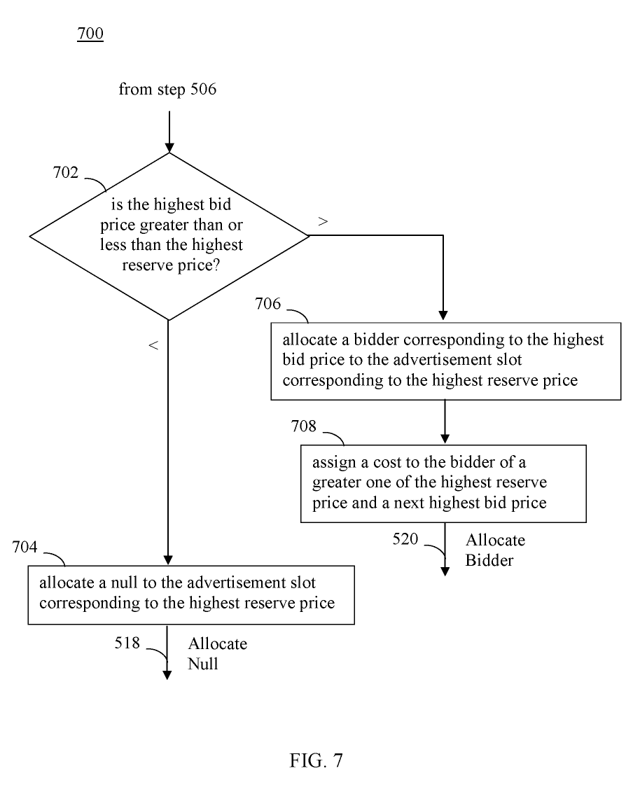

Step 508 may be performed in various ways by advertisement slot allocator 610. For instance, FIG. 7 shows a flowchart 700 that is an example embodiment for performing step 508. In an embodiment, flowchart 700 may be performed by advertisement slot allocator 610. Flowchart 700 is described as follows.

Flowchart 700 begins with step 702. In step 702, whether the highest bid price is greater than or less than the highest reserve price is evaluated. In an embodiment, advertisement slot allocator 610 evaluates comparison result 616 to determine whether the highest bid price is greater than or less than the highest reserve price. If the highest bid price is greater than the highest reserve price, steps 706 and 708 are performed by advertisement slot allocator 610. If the highest bid price is less than the highest reserve price, step 704 is performed.

In step 704, a null is allocated to the advertisement slot corresponding to the highest reserve price. Because the highest bid price is less than the highest reserve price, advertisement slot allocator 610 allocates a null to the current advertisement slot, which corresponds to the current highest reserve price. Operation proceeds from step 704 to step 510 of flowchart 500 in FIG. 5.

In step 706, a bidder corresponding to the highest bid price is allocated to the advertisement slot corresponding to the highest reserve price. Because the highest bid price is greater than the highest reserve price, advertisement slot allocator 610 allocates the current advertisement slot to the bidder that submitted the current highest bid price.

In step 708, a cost is assigned to the bidder of a greater one of the highest reserve price and a next highest bid price. As shown in FIG. 6, advertisement slot allocator 610 receives highest reserve price 614 from reserve price selector 606. Furthermore, bid price selector 604 generates a next highest bid price 602, which is a next highest bid price of advertiser bids 412 after the current highest bid price 612. Advertisement slot allocator 610 is configured to compare highest reserve price 614 and next highest bid price 602 to determine which is greater in price. The higher priced one of highest reserve price 614 and next highest bid price 602 is output by advertisement slot allocator 610 on advertisement slot allocation 414 as the cost to the bidder that submitted highest bid price 612 for displaying an advertisement and/or for having the advertisement clicked in the resulting search results webpage (e.g., in a pay-per-click scheme).

After performing steps 706 and 708, operation proceeds to step 514 of flowchart 500 in FIG. 5.

Referring back to flowchart 500, in step 510, whether all advertisement slots are allocated is evaluated. For example, in an embodiment, step 510 may be performed by reserve price selector 606. As shown in FIG. 6, reserve price selector 606 receives comparison result 616. If comparison result 616 indicates that a null was allocated to the current advertisement slot, reserve price selector 606 determines whether a next advertisement slot is present. For example, if a next reserve price is present in reserve prices 410, this indicates that a next advertisement slot does exist. In such case, operation proceeds from step 510 to step 512. If a next advertisement slot is determined to not be present by reserve price selector 606 (e.g., the current advertisement slot is the last advertisement slot on the resulting search results webpage), operation of flowchart 500 is complete.

In step 512, a next highest reserve price of the plurality of reserve prices is selected. For example, in an embodiment, step 512 may be performed by reserve price selector 606. Reserve price selector 606 may scan reserve prices 410 for a next highest reserve price, which is the next highest reserve price in reserve prices 410 after the just processed highest reserve price. As shown in FIG. 6, reserve price selector 606 outputs a highest reserve price 614, which is the newly selected next highest reserve price. Operation proceeds from step 512 back to step 506. This next highest reserve price is subsequently processed in a similar fashion as described above for the previous highest reserve price.

In step 514, whether all advertisement slots are allocated is evaluated. For example, in an embodiment, step 514 may be performed by bid price selector 604. As shown in FIG. 6, bid price selector 604 receives comparison result 616. If comparison result 616 indicates that a bidder was allocated to the current advertisement slot, bid price selector 604 consults with reserve price selector 606 (as indicated by the dotted double-headed arrow in FIG. 6) to determine whether a next advertisement slot is present. For example, as described above with respect to step 510, if reserve price selector 606 determines that a next reserve price is present in reserve prices 410, this indicates that a next advertisement slot exists. In such case, operation proceeds from step 514 to step 516. If a next advertisement slot is determined to not be present (e.g., the current advertisement slot is the last advertisement slot on the resulting search results webpage), operation of flowchart 500 is complete.

In step 516, a next highest bid price of the plurality of bid prices is selected. For example, in an embodiment, step 516 may be performed by bid price selector 604. Bid price selector 604 may scan advertiser bids 412 for a next highest bid price, which is the next bid price in advertiser bids 412 after the just processed highest bid price. As shown in FIG. 6, bid price selector 604 outputs a highest bid price 612, which is the newly selected next highest bid price. Operation proceeds from step 516 to step 512. This next highest bid price is subsequently processed in a similar fashion as described above for the previous highest bid price.

Note that sponsored search auction 600 shown in FIG. 6, including bid price selector 604, reserve price selector 606, price compare module 608, and advertisement slot allocator 610, may be implemented in hardware, software, firmware, or any combination thereof. For example, sponsored search auction 600 may be hosted in one or more computer systems that each includes one or more processors and/or logic configured to enable the functionality of sponsored search auction 600.

### Illustrative Example Embodiment

To further illustrate flowchart 500 shown in FIG. 5 and sponsored search auction 600 shown in FIG. 6, an example of the operation of flowchart 500 and sponsored search auction 600 is described as follows. This example is described with regard to example sets of reserve prices 410 and advertiser bids 412 associated with a query received from a user. This example is provided for illustrative purposes, and is not intended to be limiting. Any number and/or value of reserve prices 410 and of advertiser bids 412 may be processed according to flowchart 500 and/or sponsored search auction 600, in embodiments.

For instance, Table 1 shown below lists an example of reserve prices 410 corresponding to advertisement slots in a search results page to be displayed to a user in response to a current received query. In the current example, five advertisement slots (advertisement slots 1-5) are present in the search results page, similarly to search results webpage 300 shown in FIG. 3. Thus, five reserve prices are included in reserve prices 410:

TABLE 1

| Advertisement slot | Reserve Price |
|---|---|
| 1 (advertisement 306) | $10 |
| 2 (advertisement 318) | $8 |
| 3 (advertisement 320) | $7 |
| 4 (advertisement 322) | $4 |
| 5 (advertisement 324) | $1 |

The denomination of the reserve prices in Table 1 is shown as dollars, but in other embodiments, may have a denomination of cents, fractions of cents, or any other suitable denomination.

Table 2 shown below lists an example of advertiser bids 412 corresponding to the current query. In the current example, seven bids for seven bidders (bidders 1-7) are shown corresponding to the current query for illustrative purposes. In embodiments, any number of bids may be present, including numbers of bids in the tens, hundreds, thousands, etc.:

TABLE 2

| Bidder | Bid Price |
|---|---|
| 1 | $12 |
| 2 | $7 |
| 3 | $6 |
| 4 | $5 |
| 5 | $3 |
| 6 | $2 |
| 7 | $1 |

The denomination of the bid prices in Table 2 is shown as dollars, but in other embodiments, may have a denomination of cents, fractions of cents, or any other suitable denomination.

Referring to FIG. 6, sponsored search auction 600 may receive the reserve prices shown in Table 1 as reserve prices 410, and may receive the bid prices shown in Table 2 as advertiser bids 412. Referring to step 502 of flowchart 500, reserve price selector 606 receives reserve prices 410, and selects highest reserve price 614. In the current example of Table 1, the reserve price of $10 corresponding to the first advertisement slot (advertisement slot 1) is the highest reserve price, and thus is selected as highest reserve price 614. Operation proceeds to step 504.

In step 504, bid price selector 604 receives advertiser bids 412, and selects highest bid price 612. In the current example of Table 2, the bid price of $12 submitted by the first bidder (bidder 1) is the highest bid price, and thus is selected as highest bid price 612. Operation proceeds to step 506.

In step 506, price compare module 608 compares highest bid price 612 of $12 to highest reserve price 614 of $10. Price compare module 608 generates comparison result 612 to indicate that the highest bid price of $12 is greater than the highest reserve price of $10. Operation proceeds to step 508.

In step 508, advertisement slot allocator 610 is configured to allocate a null or a bidder corresponding to highest bid price 612 to the first advertisement slot. Referring to the example of step 508 (flowchart 700) shown in FIG. 7, in step 702, because the highest bid price of $12 is greater than the highest reserve price of $10, steps 706 and 708 are performed.

In step 706, the bidder corresponding to highest bid price 612 of $12, which is bidder 1 in Table 2, is allocated the first advertisement slot listed in Table 1, which corresponds to highest reserve price 614 of $10.

In step 708, advertisement slot allocator 610 receives highest reserve price 614 of $10 and receives next highest bid price 602, which is indicated in Table 2 as $7 (the bid price of bidder 2). Advertisement slot allocator 610 determines that highest reserve price 614 of $10 is greater than next highest bid price 602 of $7, and thus assigns a cost of $10 to bidder 1 for the first advertisement slot. Operation proceeds to step 514 in FIG. 5.

In step 514, bid price selector 604 determines that all advertisement slots are not allocated (e.g., the second-fifth advertisement slots remain to be allocated), and thus operation proceeds to step 516.

In step 516, bid price selector 604 selects the next highest bid price in Table 2, which is $7 (submitted by bidder 2), to be highest bid price 612. Operation proceeds to step 512.

In step 512, reserve price selector 606 selects the next highest reserve price in Table 1, which is $8 (corresponding to advertisement slot 2), to be highest reserve price 614. Operation proceeds to step 506.

In step 506, price compare module 608 compares highest bid price 612 of $7 to highest reserve price 614 of $8. Price compare module 608 generates comparison result 612 to indicate that the highest bid price of $7 is less than the highest reserve price of $8. Operation proceeds to step 508.

Referring to step 508 of flowchart 500, advertisement slot allocator 610 is configured to allocate a null or a bidder corresponding to highest bid price 612 to the second advertisement slot. Referring to the example of flowchart 500 in FIG. 7 (flowchart 700), in step 702, because the highest bid price of $7 is less than the highest reserve price of $8, operation proceeds to step 704.

In step 704, a null is allocated to the second advertisement slot, which corresponds to highest reserve price 614 of $8. Operation proceeds to step 510 in FIG. 5.

In step 510, reserve price selector 606 determines that all advertisement slots are not allocated (e.g., the third-fifth advertisement slots remain to be allocated), and thus operation proceeds to step 512.

In step 512, reserve price selector 606 selects the next highest reserve price in Table 1, which is $7 (corresponding to advertisement slot 3), to be highest reserve price 614. At this point, highest bid price 612 remains $7 (submitted by bidder 2). Operation proceeds to step 506.

In step 506, price compare module 608 compares highest bid price 612 of $7 to highest reserve price 614 of $7. In embodiments, sponsored search auction 600 may be configured to evaluate equal values for highest bid price 612 and highest reserve price 614 in either direction, in other words, as resulting in a null allocation to the current advertisement slot or as resulting in the bidder associated with the current highest bid price 612 being allocated the current advertisement slot. For purposes of illustration, in the current example, for equal values, sponsored search auction 600 is configured to allocate the current advertisement slot to the bidder associated with the current highest bid price. Thus, in the current example, price compare module 608 generates comparison result 612 to indicate that the highest bid price of $7 is greater than (or equal to) the highest reserve price of $7. Operation proceeds to step 508.

Referring to step 508 of flowchart 500, advertisement slot allocator 610 is configured to allocate a null or a bidder corresponding to highest bid price 612 to the third advertisement slot. Referring to the example of flowchart 500 in FIG. 7 (flowchart 700), in step 702, because the highest bid price of $7 is greater than (or equal to) the highest reserve price of $7, steps 706 and 708 are performed.

In step 706, the bidder corresponding to highest bid price 612 of $7, which is bidder 2 in Table 2, is allocated the third advertisement slot listed in Table 1, which corresponds to highest reserve price 614 of $7.

In step 708, advertisement slot allocator 610 receives highest reserve price 614 of $7 and receives next highest bid price 602, which is indicated in Table 2 as $6. Advertisement slot allocator 610 determines that highest reserve price 614 of $7 is greater than next highest bid price 602 of $6, and thus assigns a cost of $7 to bidder 2 for the third advertisement slot. Operation proceeds to step 514 in FIG. 5.

In step 514, bid price selector 604 determines that all advertisement slots are not allocated (e.g., the fourth and fifth advertisement slots remain to be allocated), and thus operation proceeds to step 516.

In step 516, bid price selector 604 selects the next highest bid price in Table 2, which is $6 (submitted by bidder 3), to be highest bid price 612. Operation proceeds to step 512.

In step 512, reserve price selector 606 selects the next highest reserve price in Table 1, which is $4 (corresponding to advertisement slot 4), to be highest reserve price 614. Operation proceeds to step 506.

In step 506, price compare module 608 compares highest bid price 612 of $6 to highest reserve price 614 of $4. Price compare module 608 generates comparison result 612 to indicate that the highest bid price of $6 is greater than the highest reserve price of $4. Operation proceeds to step 508.

Referring to step 508 of flowchart 500, advertisement slot allocator 610 is configured to allocate a null or a bidder corresponding to highest bid price 612 to the fourth advertisement slot. Referring to the example of flowchart 500 in FIG. 7 (flowchart 700), in step 702, because the highest bid price of $6 is greater than the highest reserve price of $4, steps 706 and 708 are performed.

In step 706, the bidder corresponding to highest bid price 612 of $6, which is bidder 3 in Table 2, is allocated the fourth advertisement slot listed in Table 1, which corresponds to highest reserve price 614 of $4.

In step 708, advertisement slot allocator 610 receives highest reserve price 614 of $4 and receives next highest bid price 602, which is indicated in Table 2 as $5. Advertisement slot allocator 610 determines that highest reserve price 614 of $4 is less than next highest bid price 602 of $5, and thus assigns a cost of $5 to bidder 3 for the fourth advertisement slot. Operation proceeds to step 514 in FIG. 5.

In step 514, bid price selector 604 determines that all advertisement slots are not allocated (e.g., the fifth advertisement slot remains to be allocated), and thus operation proceeds to step 516.

In step 516, bid price selector 604 selects the next highest bid price in Table 2, which is $5 (submitted by bidder 4), to be highest bid price 612. Operation proceeds to step 512.

In step 512, reserve price selector 606 selects the next highest reserve price in Table 1, which is $1 (corresponding to advertisement slot 5), to be highest reserve price 614. Operation proceeds to step 506.

In step 506, price compare module 608 compares highest bid price 612 of $5 to highest reserve price 614 of $1. Price compare module 608 generates comparison result 612 to indicate that the highest bid price of $5 is greater than the highest reserve price of $1. Operation proceeds to step 508.

Referring to step 508 of flowchart 500, advertisement slot allocator 610 is configured to allocate a null or a bidder corresponding to highest bid price 612 to the fourth advertisement slot. Referring to the example of flowchart 500 in FIG. 7 (flowchart 700), in step 702, because the highest bid price of $5 is greater than the highest reserve price of $1, steps 706 and 708 are performed.

In step 706, the bidder corresponding to highest bid price 612 of $5, which is bidder 4 in Table 2, is allocated the fifth advertisement slot listed in Table 1, which corresponds to highest reserve price 614 of $1.

In step 708, advertisement slot allocator 610 receives highest reserve price 614 of $1 and receives next highest bid price 602, which is indicated in Table 2 as $3. Advertisement slot allocator 610 determines that highest reserve price 614 of $1 is less than next highest bid price 602 of $3, and thus assigns a cost of $3 to bidder 4 for the fourth advertisement slot. Operation proceeds to step 514 in FIG. 5.

In step 514, bid price selector 604 determines that all advertisement slots are allocated (e.g., each of first-fifth advertisement slots is either allocated to a bidder or is allocated a null), and thus operation of flowchart 500 is complete.

Referring to FIG. 6, advertisement slot allocator 610 generates advertisement slot allocation 414, which indicates which bidders are allocated which advertisement slots, and what costs are assigned to the bidders. In the current example, advertisement slot bidder allocation 414 may contain the information shown below in Table 3:

TABLE 3

| Advertisement slot | Bidder | Cost |
|---|---|---|
| 1 (advertisement 306) | 1 | $10 |
| 2 (advertisement 318) | NULL | |
| 3 (advertisement 320) | 2 | $7 |
| 4 (advertisement 322) | 3 | $5 |
| 5 (advertisement 324) | 4 | $3 |

### Example Computer Implementation

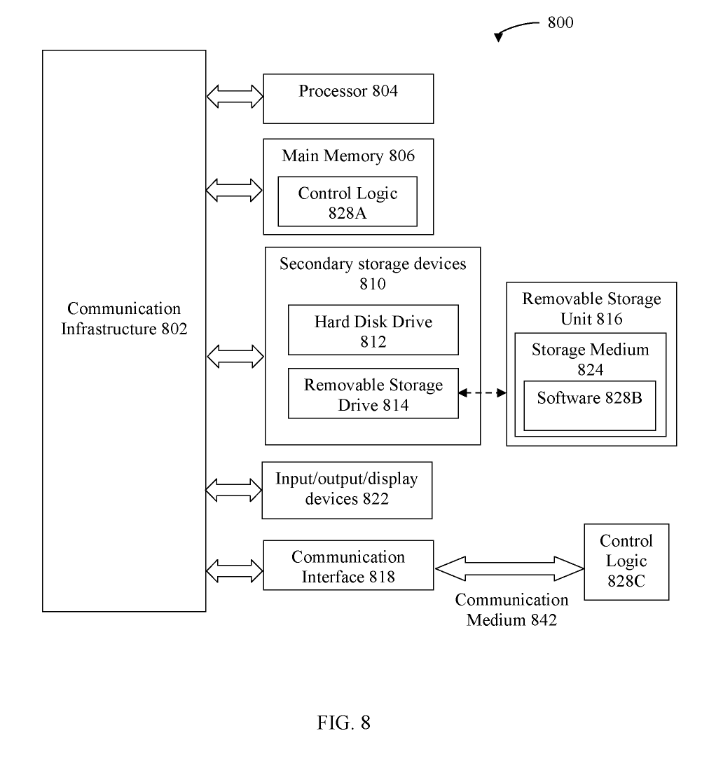

The embodiments described herein, including systems, methods/processes, and/or apparatuses, may be implemented using well known servers/computers, such as a computer 800 shown in FIG. 8. For example, search engine 400 of FIG. 4, sponsored search auction 600 shown in FIG. 6, flowchart 500 shown in FIG. 5, and flowchart 700 shown in FIG. 7, can be implemented using one or more computers 800.

Computer 800 can be any commercially available and well known computer capable of performing the functions described herein, such as computers available from International Business Machines, Apple, Sun, HP, Dell, Cray, etc. Computer 800 may be any type of computer, including a desktop computer, a server, etc.

Computer 800 includes one or more processors (also called central processing units, or CPUs), such as a processor 804. Processor 804 is connected to a communication infrastructure 802, such as a communication bus. In some embodiments, processor 804 can simultaneously operate multiple computing threads.

Computer 800 also includes a primary or main memory 806, such as random access memory (RAM). Main memory 806 has stored therein control logic 828A (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 824 having stored therein computer software 828B (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well known manner.

Computer 800 also includes input/output/display devices 822, such as monitors/displays, keyboards, pointing devices, etc.

Computer 800 further includes a communication or network interface 818. Communication interface 818 enables the computer 800 to communicate with remote devices. For example, communication interface 818 allows computer 800 to communicate over communication networks or mediums 842 (representing a form of a computer useable or readable medium), such as LANs, WANs, the Internet, etc. Network interface 818 may interface with remote sites or networks via wired or wireless connections.

Control logic 828C may be transmitted to and from computer 800 via the communication medium 842.

Any apparatus or manufacture comprising a computer useable or readable medium having control logic (software) stored therein is referred to herein as a computer program product or program storage device. This includes, but is not limited to, computer 800, main memory 806, secondary storage devices 810, and removable storage unit 816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing search engine 400, query processor 402 (FIG. 4), sponsored search auction 404 (FIG. 4), sponsored search auction 600, bid price selector 604 (FIG. 6), reserve price selector 606 (FIG. 6), price compare module 608 (FIG. 6), advertisement slot allocator 610 (FIG. 6), flowchart 500, flowchart 700, and/or further embodiments of the present invention described herein. Embodiments of the invention are directed to computer program products comprising such logic (e.g., in the form of program code or software) stored on any computer useable medium. Such program code, when executed in a processing unit (that includes one or more data processing devices), causes a device to operate as described herein.

The invention can work with software, hardware, and/or operating system implementations other than those described herein. Any software, hardware, and operating system implementations suitable for performing the functions described herein can be used.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for a sponsored search auction, comprising:
selecting a highest reserve price of a plurality of reserve prices corresponding to a plurality of advertisement slots of a page;
selecting a highest bid price of a plurality of bid prices for the advertisement slots of the page corresponding to a plurality of bidders;
comparing the highest bid price to the highest reserve price;
allocating a null or a bidder corresponding to the highest bid price to the advertisement slot corresponding to the highest reserve price based on said comparing;
repeating said comparing and said allocating for a next highest bid price and a next highest reserve price if a bidder is allocated to the advertisement slot during said allocating and if all advertisements slots are not yet allocated; and
repeating said comparing and said allocating for a next highest reserve price if a null is allocated to the advertisement slot during said allocating and if all advertisements slots are not yet allocated.

2. The method of claim 1, wherein said allocating comprises:
if the highest bid price is greater than the highest reserve price,
allocating a bidder corresponding to the highest bid price to the advertisement slot corresponding to the highest reserve price,
assigning a cost to the bidder of a greater one of the highest reserve price or a next highest bid price.

3. The method of claim 1, wherein said allocating comprises:
if the highest bid price is less than the highest reserve price,
allocating a null to the advertisement slot corresponding to the highest reserve price.

4. A sponsored search auction, comprising:
a reserve price selector configured to select a highest reserve price of a plurality of reserve prices corresponding to a plurality of advertisement slots of a page;
a bid price selector configured to select a highest bid price of a plurality of bid prices for the advertisement slots of the page corresponding to a plurality of bidders;
a price compare module configured to compare the highest bid price to the highest reserve price of the plurality of reserve prices corresponding to an advertisement slot that is unallocated, and to generate a compare result; and
an advertisement slot allocator configured to allocate a null or a bidder corresponding to the highest bid price to the advertisement slot corresponding to the highest reserve price based on the compare result;
wherein the price compare module is configured to repeat performing the comparison and the advertisement slot allocator is configured to repeat performing the allocation for a next highest bid price selected by the bid price selector and a next highest reserve price selected by the reserve price selector if a bidder is allocated to the advertisement slot during an immediately preceding allocation performed by the advertisement slot allocator and if all advertisements slots are not yet allocated; and
wherein the price compare module is configured to repeat performing the comparison and the advertisement slot allocator is configured to repeat performing the allocation for a next highest reserve price selected by the reserve price selector if a null is allocated to the advertisement slot during an immediately preceding allocation performed by the advertisement slot allocator and if all advertisements slots are not yet allocated.

5. The sponsored search auction of claim 4, wherein the advertisement slot allocator is configured to allocate a bidder corresponding to the highest bid price to the advertisement slot corresponding to the highest reserve price, and to assign a cost to the bidder of a greater one of the highest reserve price or a next highest bid price if the comparison result indicates that the highest bid price is greater than the highest reserve price.

6. The sponsored search auction of claim 4, wherein the advertisement slot allocator is configured to allocate a null to the advertisement slot corresponding to the highest reserve price if the comparison result indicates that the selected highest bid price is less than the highest reserve price.

7. A search engine, comprising:
a query processor configured to receive a query from an electronic device associated with a user, to determine a plurality of reserve prices corresponding to a plurality of advertisement slots of a search results page, and to determine a plurality of bid prices for the advertisement slots of the search results page corresponding to a plurality of bidders; and
a sponsored search auction configured to allocate a bidder or a null to each advertisement slot of the search results page.

8. The search engine of claim 7, wherein the sponsored search auction comprises:
a reserve price selector configured to select a highest reserve price of the plurality of reserve prices corresponding to an advertisement slot that is unallocated;
a bid price selector configured to select a highest bid price of the plurality of bid prices;
a price compare module configured to compare the highest bid price to the highest reserve price, and to generate a compare result; and
an advertisement slot allocator configured to allocate a null or a bidder corresponding to the highest bid price to the advertisement slot corresponding to the highest reserve price based on the compare result;
wherein the price compare module is configured to repeat performing the comparison and the advertisement slot allocator is configured to repeat performing the allocation for a next highest bid price selected by the bid price selector and a next highest reserve price selected by the reserve price selector if a bidder is allocated to the advertisement slot during an immediately preceding allocation performed by the advertisement slot allocator and if all advertisements slots are not yet allocated; and
wherein the price compare module is configured to repeat performing the comparison and the advertisement slot allocator is configured to repeat performing the allocation for a next highest reserve price selected by the reserve price selector if a null is allocated to the advertisement slot during an immediately preceding allocation performed by the advertisement slot allocator and if all advertisements slots are not yet allocated.

9. The search engine of claim 7, wherein the advertisement slot allocator is configured to allocate a bidder corresponding to the highest bid price to the advertisement slot corresponding to the highest reserve price, and to assign a cost to the bidder of a greater one of the highest reserve price or a next highest bid price if the comparison result indicates that the highest bid price is greater than the highest reserve price.

10. The search engine of claim 7, wherein the advertisement slot allocator is configured to allocate a null to the advertisement slot corresponding to the highest reserve price if the comparison result indicates that the selected highest bid price is less than the highest reserve price.

11. The search engine of claim 7, further comprising:
a reserve prices database that stores the plurality of reserve prices; and
an advertiser bids database that stores the plurality of bid prices.

12. A computer program product comprising a computer usable medium having computer readable logic embodied in said medium for enabling a processing unit to perform a sponsored search auction, comprising:
first means for enabling the processing unit to select a highest reserve price of a plurality of reserve prices corresponding to a plurality of advertisement slots of a page;
second means for enabling the processing unit to select a highest bid price of a plurality of bid prices for the advertisement slots of the page corresponding to a plurality of bidders;
third means for enabling the processing unit to compare the highest bid price to the highest reserve price to generate a comparison result;
fourth means for enabling the processing unit to allocate a null or a bidder corresponding to the highest bid price to the advertisement slot corresponding to the highest reserve price based on the comparison result;
fifth means for enabling the processing unit to repeat performing the compare by the third means and the allocate by the fourth means for a next highest bid price and a next highest reserve price if a bidder is allocated to the advertisement slot during the allocate and if all advertisements slots are not yet allocated; and
sixth means for enabling the processing unit to repeat performing the compare by the third means and the allocate by the fourth means for a next highest reserve price if a null is allocated to the advertisement slot during the allocate and if all advertisements slots are not yet allocated.

13. The computer program product of claim 12, wherein said fourth means comprises:
seventh means for enabling the processing unit to allocate a bidder corresponding to the highest bid price to the advertisement slot corresponding to the highest reserve price if the highest bid price is greater than the highest reserve price; and
eighth means for enabling the processing unit to assign a cost to the bidder of a greater one of the highest reserve price or a next highest bid price if the highest bid price is greater than the highest reserve price.

14. The computer program product of claim 12, wherein said fourth means comprises:
seventh means for enabling the processing unit to evaluate allocate a null to the advertisement slot corresponding to the highest reserve price if the highest bid price is less than the highest reserve price.
